(19) United States
(12) Patent Application Publication
(10) Pub. No.: US 2022/0284279 A1
(43) Pub. Date: Sep. 8, 2022

(54) COMPUTATIONAL TECHNIQUES FOR IDENTIFYING THE SURFACE OF A BRAIN

(71) Applicant: X Development LLC, Mountain View, CA (US)

(72) Inventors: Sarah Ann Laszlo, Mountain View, CA (US); Lam Thanh Nguyen, Mountain View, CA (US)

(21) Appl. No.: 17/190,915

(22) Filed: Mar. 3, 2021

(51) Int. Cl. G06N 3/08; G06N 3/04

(52) U.S. Cl. CPC G06N 3/08; G06N 3/0454

(57) ABSTRACT

In one aspect, there is provided a method performed by one or more data processing apparatus that includes obtaining a point cloud dataset representing a brain of a biological organism. The point cloud dataset includes a collection of brain points that each define a respective spatial location in the brain. The method further includes identifying multiple brain points from the point cloud dataset as being located on a surface of the brain by repeatedly performing operations including initializing a current value of a position parameter and iteratively adjusting the current value of the position parameter until a termination criterion is satisfied. The termination criterion is satisfied if at least one brain point from the point cloud dataset is included in an interior of a shape parameterized by the current value of the position parameter. The operations further include, after determining that the termination criterion is satisfied, identifying each brain point from the point cloud dataset that is included in the interior of the shape parameterized by the current value of the position parameter as being located on the surface of the brain.

### BACKGROUND

This specification relates to identifying the surface of a brain of a biological organism.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations for identifying the surface of a brain of a biological organism from a point cloud dataset representing points (e.g., spatial locations) in the brain.

According to a first aspect, there is provided a method performed by one or more data processing apparatus that includes obtaining a point cloud dataset representing a brain of a biological organism. The point cloud dataset includes a collection of brain points that each define a respective spatial location in the brain. The method further includes identifying multiple brain points from the point cloud dataset as being located on a surface of the brain by repeatedly performing operations including initializing a current value of a position parameter and iteratively adjusting the current value of the position parameter until a termination criterion is satisfied. The termination criterion is satisfied if at least one brain point from the point cloud dataset is included in an interior of a shape parameterized by the current value of the position parameter. The operations further include, after determining that the termination criterion is satisfied, identifying each brain point from the point cloud dataset that is included in the interior of the shape parameterized by the current value of the position parameter as being located on the surface of the brain.

In some implementations, the biological organism is an animal. In some implementations, the biological organism is a fly. In some implementations, the shape parametrized by the current value of the position parameter is a sphere having a predefined radius.

In some implementations, initializing the current value of the position parameter includes initializing a box that encloses the point cloud dataset, and initializing the current value of the position parameter such that the shape parametrized by the position parameter is positioned at a boundary of the box.

In some implementations, the method further includes rendering a visualization of the multiple brain points identified as being located on the surface of the brain. The visualization comprises multiple markers, and each marker indicates a position of each brain point of multiple brain points.

In some implementations, the method is performed by multiple data processing apparatus in parallel.

In some implementations, the method further includes obtaining graph data defining a synaptic connectivity graph that represents synaptic connectivity between neurons in the brain of the biological organism and includes multiple nodes and edges; and instantiating a reservoir computing neural network including: (i) a brain emulation neural network having a neural network architecture that is specified by the synaptic connectivity graph and (ii) a prediction neural network.

In some implementations, instantiating the reservoir computing network includes instantiating the brain emulation neural network having the neural network architecture that is specified by the synaptic connectivity graph, which includes mapping each node in the synaptic connectivity graph to a corresponding artificial neuron in the neural network architecture; and mapping each edge connecting a pair of nodes in the synaptic connectivity graph to a connection between a corresponding pair of artificial neurons in the neural network architecture.

In some implementations, mapping each node in the synaptic connectivity graph to a corresponding artificial neuron in the neural network architecture includes mapping each node that corresponds to one or more brain points of the multiple brain points identified as being located on the surface of the brain to a corresponding artificial input neuron in the neural network architecture.

In some implementations, instantiating the reservoir computing network includes instantiating the brain emulation neural network having the neural network architecture that is specified by a sub-graph of the synaptic connectivity graph. The sub-graph is selected based on a visualization of the multiple brain points identified as being located on the surface of the brain.

In some implementations, each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism.

In some implementations, the reservoir computing network is configured to process an input that comprises image data, video data, audio data, odor data, point cloud data, magnetic field data, or a combination thereof, to generate an output.

In some implementations, iteratively adjusting the current value of the position parameter includes changing a position of the shape parametrized by the current value of the position parameter along the same direction at each iteration.

In some implementations, iteratively adjusting the current value of the position parameter includes changing a position of the shape parametrized by the current value of the position parameter along a random direction at each iteration.

According to a second aspect there are provided one or more non-transitory computer storage media storing instructions that when executed by one or more computers cause the one or more computers to perform the operations of the method of any preceding aspect.

According to a third aspect there is provided a system including: one or more computers; and one or more storage devices communicatively coupled to the one or more computers, where the one or more storage devices store instructions that, when executed by the one or more computers, cause the one or more computers to perform the operations of the method of any preceding aspect.

Particular embodiments of the subject matter described in this specification can be implemented so as to realize one or more of the following advantages.

The brain of a biological organism can be represented as a point cloud dataset containing a collection of brain points, where each brain point defines a respective spatial location in the brain. For example, each brain point can correspond to a voxel in an image of the brain obtained by a microscopy technique such as, e.g., electron microscopy. Accordingly, each brain point can have a respective resolution on the order of a few nanometers, e.g., 4 nanometers. The point cloud dataset can be extremely large because of the large number of voxels that are included in the image of the brain.

Due to the surface of the brain having a highly irregular topology and the point cloud dataset being extremely large, it is generally difficult to identify which brain points in the point cloud dataset are located on the surface of the brain. Knowing which brain points are located on the surface can be important, however, since they represent input channels for information flow into the brain and provide a reference against which different regions of the brain can be located, such as, e.g., the input terminal of the optic lobe that accepts visual input from the eye. The systems described in this specification can identify the surface of the brain robustly, in a reasonable amount of time, and to an arbitrarily precise resolution. Moreover, since identifying the surface of the brain can be computationally infeasible in practice due to the enormity of the dataset involved, the systems described in this specification enable parallelization and thereby make the problem of surface identification tractable.

The information about the surface of the brain can be used in reservoir computing applications. In particular, a “reservoir computing” neural network can be implemented with an architecture specified by a brain emulation sub-network followed by a “prediction” sub-network. The brain emulation sub-network is a neural network having an architecture specified by a synaptic connectivity graph that represents the structure of synaptic connections between neurons in the brain of a biological organism. The systems described in this specification can identify which neurons in the brain of the biological organism are located on the brain's surface, and identify corresponding artificial neurons in the brain emulation sub-network as being input neurons e.g., as neurons that receive the input into the brain emulation sub-network.

The brain emulation neural network can be implemented with an architecture including artificial input neurons that correspond to neurons located on the surface of the brain of the biological organism, where the former neuron type receive input into the network and the latter neuron type receive input from external stimuli into the brain. This functional correspondence can enable the brain emulation neural network to perform certain tasks more effectively while consuming fewer computational resources (e.g. memory and computing power). Further, the brain emulation neural network can require fewer training iterations and achieve a higher prediction accuracy. In one example, the brain emulation neural network can be configured to perform image processing tasks, and the architecture of the brain emulation neural network can be specified by a sub-graph corresponding to only the visual system of the brain (i.e., to visual type neurons) with artificial input neurons specified by visual type input neurons in the brain.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of obtaining a point cloud dataset representing the brain of a biological organism and a brain surface processing system.

FIG. 2A illustrates the brain surface processing system iteratively adjusting a current value of the position parameter.

FIG. 2B illustrates the brain surface processing system iteratively adjusting current values of multiple position parameters.

FIG. 3 illustrates brain points identified as being located on the surface of the brain.

FIG. 4 is a flow diagram of an example process for identifying a surface of the brain.

FIG. 5 shows an example data flow for generating a synaptic connectivity graph and a brain emulation neural network based on the brain of a biological organism.

FIG. 6 shows an example reservoir computing system.

FIG. 7 is a block diagram of an example computer system.

Like reference numbers and designations in the various drawings indicate like elements.

### DETAILED DESCRIPTION

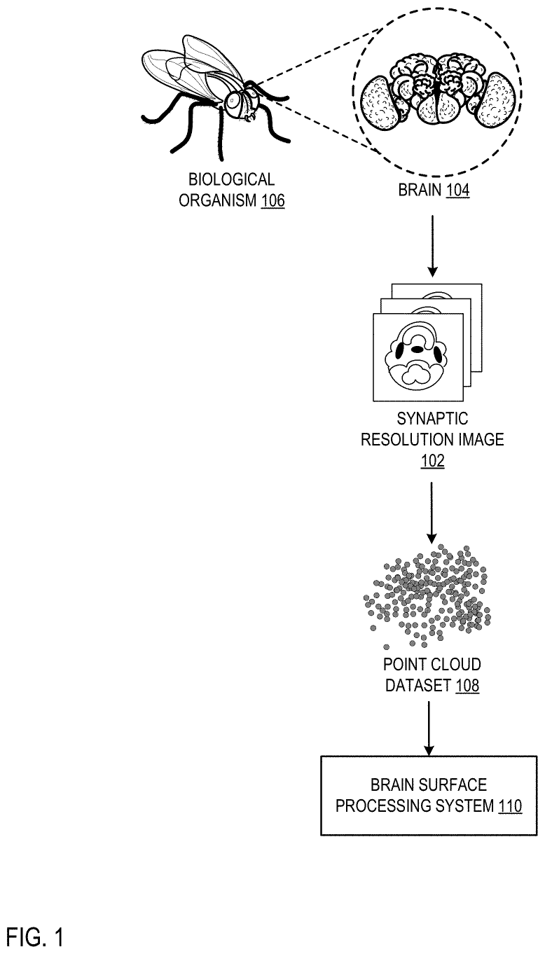

FIG. 1 illustrates an example of obtaining a point cloud dataset 108 containing a collection of brain points from a synaptic resolution image 102 of the brain 104 of a biological organism 106. Each brain point of the point cloud dataset 108 defines a respective spatial location in the brain 104. As used throughout this document, the brain 104 may refer to any amount of nervous tissue from a nervous system of the biological organism 106, and nervous tissue may refer to any tissue that includes neurons (i.e., nerve cells). The surface of the brain 104 can refer to an outer layer of the nervous tissue that can contain sensory nerve cells e.g., the nerve cells that function as input channels for external and internal stimuli. The biological organism 106 can be, e.g., a worm, a fly, a mouse, a cat, or a human. The synaptic resolution image 102 can be processed to generate the point cloud dataset 108, and a brain surface processing system 110 can identify the brain points in the point cloud dataset 108 that are located on the surface of the brain 104 (e.g., the exterior surface of the brain) of the biological organism 106. This information can be used in reservoir computing applications.

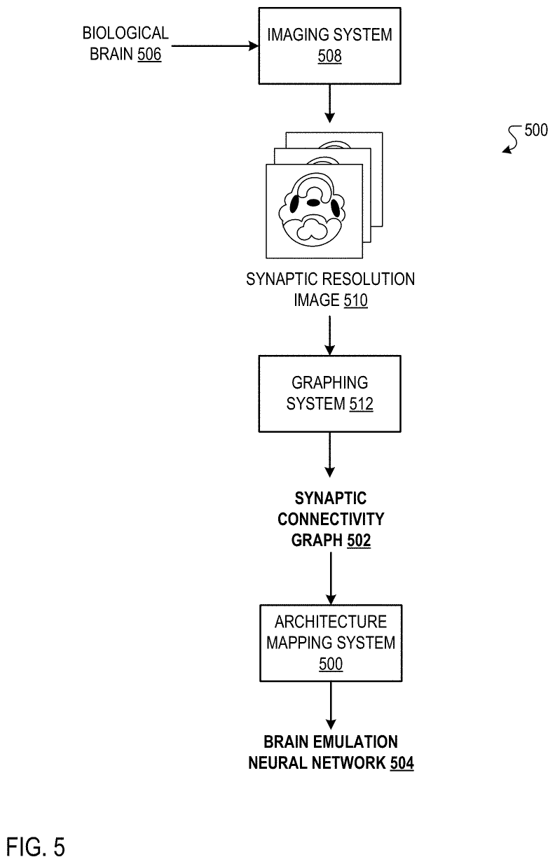

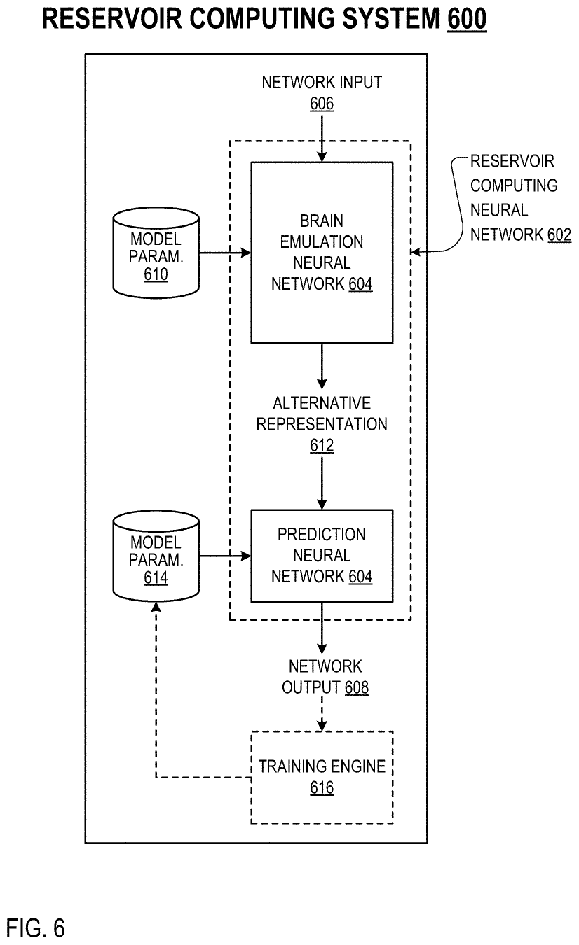

As will be described in more detail below with reference to FIG. 5, the systems described in this specification can generate a synaptic connectivity graph and a brain emulation neural network based on an image of the brain of a biological organism. The brain of a biological organism can be adapted by evolutionary pressures to be effective at solving certain tasks, e.g., classifying objects, or generating robust object representations, and brain emulation neural network can share this capacity to effectively solve tasks. The information about the surface of the brain 104, obtained by the brain surface processing system 110, can be used to instantiate a brain emulation sub-network of a reservoir computing neural network, which will be described in more detail below with reference to FIG. 6.

As described above, each brain point in the point cloud dataset 108 defines a respective location in the brain 104 of the biological organism 106. The point cloud dataset 108 can be represented as a list of brain points, e.g., as an N×3 array specifying x, y, and z, coordinates for each of the N number of brain points in the dataset 108. The list of brain points can be obtained, e.g., from a synaptic resolution image of the brain by using flood-filling networks, which are described in more detail in: Peter H. Li, et al., “Automated Reconstruction of a Serial-Section EM Drosophila Brain with Flood-Filling Networks and Local Realignment,” bioRxiv doi: 10.1101/605634 (2020).

The brain surface processing system 110 can identify a proper subset of the brain point dataset 108 containing only those brain points that are located on the surface of the brain 104.

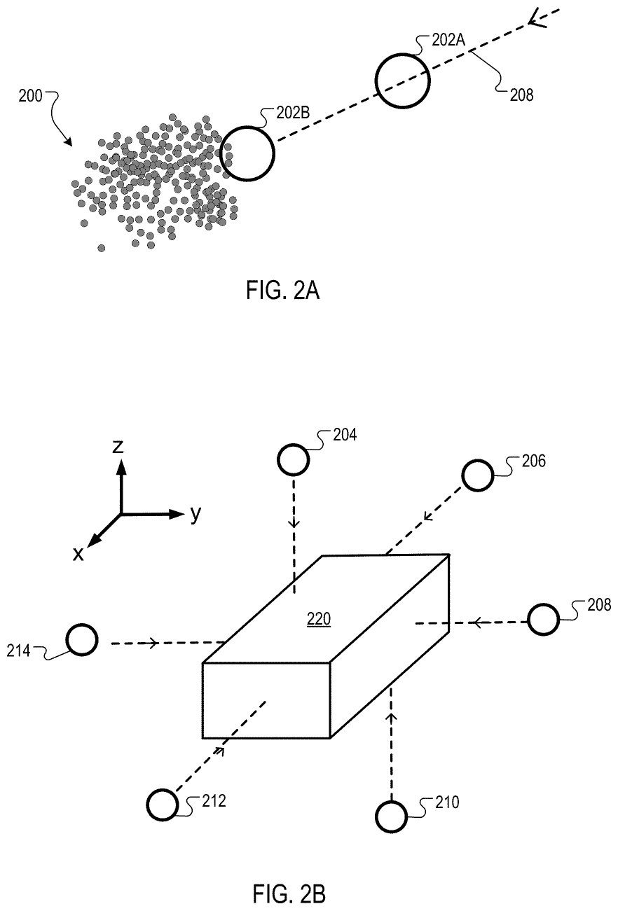

FIGS. 2A and 2B illustrate an example of the system 110 identifying brain points located on the surface of the brain 104. The system 110 is a system of one or more computers located in one or more locations.

FIG. 2A illustrates a point cloud dataset 200 containing brain points, each defining a respective spatial location in the brain 104 of a biological organism 106. FIG. 2A also illustrates a shape parametrized by a position parameter. The shape can be, e.g., a sphere having a predefined radius, or any other shape having an interior with three-dimensional volume. The value of the position parameter can define the spatial location of the shape, e.g., by defining the x, y, and z coordinates of the center of the sphere.

The brain surface processing system 110 can iteratively adjust the current value of the position parameter, e.g., from position 202A to position 202B. The second position 202B can be located closer in space to the point cloud dataset 200 than the first position 202A. The system 110 can randomly initialize the first current value 202A of the position parameter, or it can initialize it as described in more detail below with reference to FIG. 2B. The value of the position parameter is initialized so that none of the brain points of the point cloud dataset 108 are initially included in the interior of the shape parametrized by the position parameter e.g., as illustrated for the shape located at position 202A in FIG. 2.

The system 110 can iteratively adjust the current value of the position parameter until a termination criterion is satisfied. The termination criterion can be satisfied when the coordinates associated with the position of any of the brain points in the point cloud dataset 108 are included in the interior of the shape parametrized by the position parameter, e.g., included inside the sphere, as illustrated for the shape located at position 202B in FIG. 2.

For example, as shown in FIG. 2A, when the shape is located at the position 202B, some of the brain points in the point cloud dataset 200 are contained inside the sphere. Each time the system 110 changes the current value of the position parameter from the first position 202A, to the second position 202B, the system 110 checks the coordinates of each of the brain points in the point cloud dataset 200 against the coordinates associated with the current value of the position parameter (and/or other predefined parameters associated with the shape, e.g., the radius of the sphere) to determine whether the termination criterion is satisfied. If the termination criterion is not satisfied, the system 110 adjusts the current value of the position parameter to a new current value having different coordinates along the path 208.

If the termination criterion is satisfied, the system 110 identifies each point in the point cloud dataset 108 that is included in the interior of the shape parametrized by the position parameter as being located on the surface of the brain 104. The system 110 can initialize a new current value of the position parameter and iteratively adjust it along some other path, different from the path 208.

The path 208 can be a random walk path, e.g., it can be determined by a succession of steps taken in a random direction at each iteration. Alternatively, the path 208 can be parallel to an axis of the rectangular box, e.g., it can be determined by a succession of steps taken in the same direction at each iteration. Each step (e.g., the difference between the first current value and the second current value of the position parameter) can correspond to a predefined distance that can be determined based on the desired resolution of the brain surface identification. For example, the smaller the step, the higher the resolution.

FIG. 2B illustrates the system 110 initializing multiple shapes (204, 206, 208, 210, 212, 214), each parametrized by a position parameter. The system 110 can initialize any number of shapes and iteratively adjust the values of the position parameters simultaneously. For example, the system 110 can include multiple computing units (e.g., threads or CPUs) which can operate (e.g., adjust values of the position parameters) in parallel. The computing units can finish operating (e.g., reach termination criterion) at different times. The system 110 can check if the termination criterion is satisfied for each of the shapes independently. In this way, the system 110 can improve the efficiency of identifying which brain points in the point cloud dataset 108 are located on the surface of the brain 104.

Instead of randomly initializing the current values of the position parameters, the system 110 can firstly initialize a volume 220 e.g., a rectangular box, enclosing all brain points in the point cloud dataset 200. The system 110 can initialize the current values of the position parameters each having coordinates associated with a boundary of the rectangular box, to ensure that each of the shapes is initially positioned as close to the point cloud 200 as possible and, at the same time, that none of the shapes includes any brain points inside the interior. In this way, the system 110 can minimize the number of iterations (e.g., steps) until the termination criterion is satisfied (e.g., until a shape includes at least one brain point inside the interior), thereby improving the efficiency of identifying which points in the point cloud dataset 200 are located on the surface of the brain 104.

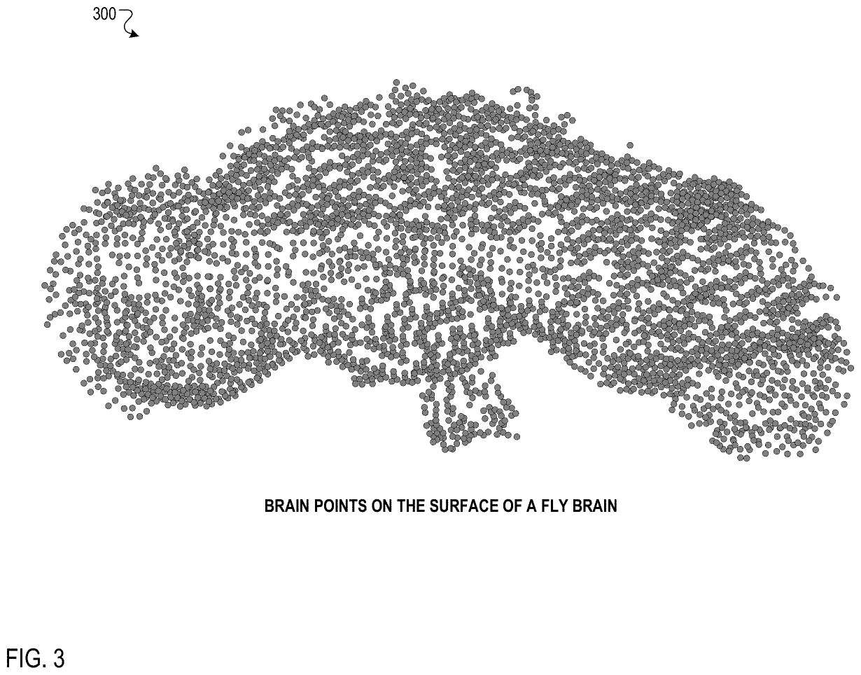

FIG. 3 illustrates brain points 300 of the point cloud dataset 108 identified as being located on the surface of the brain 104 by the system 110. The visualization shows markers (e.g. spheres) indicating the positions of brain points defined by the position (e.g., in Cartesian coordinates) of the corresponding voxel in the brain 104 of the biological organism 106. A user can be provided with access to a visualization of the brain's surface (e.g., a point cloud plot of all surface brain points) and can adaptively adjust the view to various magnifications, e.g., “zoom-in” on a particular brain point, “zoom-out” to visualize the whole of the surface, and change viewing perspective by e.g., rotating or translating the surface. The user can perform any other appropriate manipulations of the visualization.

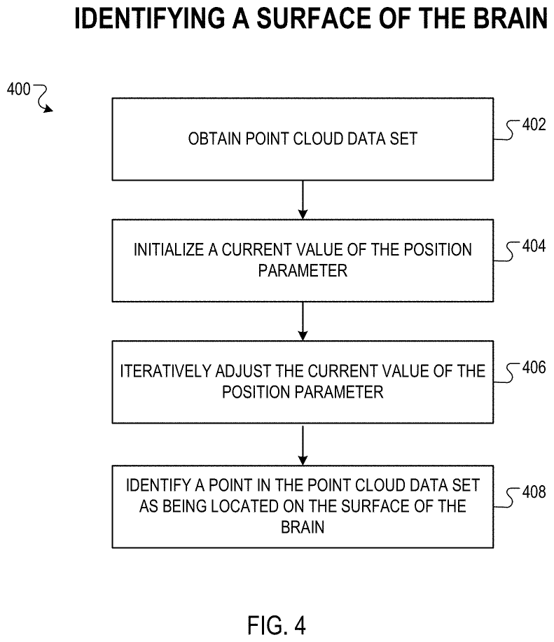

FIG. 4 is a flow diagram of an example process 400 for identifying the surface of the brain 104 of the biological organism 106. For convenience, the process 400 will be described as being performed by the brain surface processing system 110, which is a system of one or more computers located in one or more locations.

The system 110 obtains a point cloud dataset representing the brain of the biological organism (402). As described above, the point cloud dataset includes a collection of brain points that each define a respective spatial location in the brain.

The system 110 identifies a number of brain points from the point cloud dataset as being located on a surface of the brain by firstly initializing a current value of a position parameter (404). The system 110 can initialize a current value of multiple position parameters simultaneously, e.g., in parallel.

The system 110 iteratively adjusts the respective current value of each position parameter until a termination criterion is satisfied for the position parameter. The termination criterion for a position parameter is satisfied if at least one brain point from the point cloud dataset is included in an interior of a shape parameterized by the current value of the position parameter (406). The system 110 can iteratively adjust the current values of multiple position parameters, and check if the termination criterion is satisfied for each of the position parameters, simultaneously, e.g., in parallel.

After determining that the termination criterion is satisfied, the system 110 identifies each brain point from the point cloud dataset that is included in the interior of the shape parameterized by the current value of the position parameter as being located on the surface of the brain (408). The system 110 can identify brain points included in the interior of multiple shapes, each parametrized by a current value of a respective position parameter, as being located on the surface of the brain simultaneously, e.g., in parallel.

The system can continue repeating the process 400 until a termination criterion for the process 400 is satisfied. The termination criterion for the process 400 can be, e.g., that a predefined number of positioned parameters have been initialized and repeatedly adjusted to identify one or more respective brain points on the surface of the brain.

As mentioned above, the information about the surface of the brain can be used by the systems described in this specification in reservoir computing applications. For example, the information about the surface of the brain can be used to instantiate a brain emulation neural network, which can form a sub-network of a reservoir computing system. The brain emulation neural is a neural network having an architecture specified by a synaptic connectivity graph that defines synaptic connections between neurons in the brain of a biological organism. The data flow for generating the brain emulation neural network will be described in more detail next.

FIG. 5 shows an example data flow for generating a synaptic connectivity graph and a brain emulation neural network based on the brain of a biological organism. The synaptic connectivity graph refers to a graph representing the structure of synaptic connections between neurons in the brain of a biological organism, e.g., a fly. The synaptic connectivity graph includes a set of nodes and edges, where each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism.

An imaging system 508 can be used to generate a synaptic resolution image 510 of the brain 506. An image of the brain 506 can be referred to as having synaptic resolution if it has a spatial resolution that is sufficiently high to enable the identification of at least some synapses in the brain 506. Put another way, an image of the brain 506 can be referred to as having synaptic resolution if it depicts the brain 506 at a magnification level that is sufficiently high to enable the identification of at least some synapses in the brain 506. The image 510 can be a volumetric image, i.e., that characterizes a three-dimensional representation of the brain 506. The image 510 can be represented in any appropriate format, e.g., as a three-dimensional array of numerical values.

The imaging system 508 can be any appropriate system capable of generating synaptic resolution images, e.g., an electron microscopy system. The imaging system 508 may process “thin sections” from the brain 506 (i.e., thin slices of the brain attached to slides) to generate output images that each have a field of view corresponding to a proper subset of a thin section. The imaging system 508 may generate a complete image of each thin section by stitching together the images corresponding to different fields of view of the thin section using any appropriate image stitching technique. The imaging system 508 may generate the volumetric image 510 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system 512 is configured to process the synaptic resolution image 510 to generate the synaptic connectivity graph 502. The synaptic connectivity graph 502 specifies a set of nodes and a set of edges, such that each edge connects two nodes. To generate the graph 502, the graphing system 512 identifies each neuron in the image 510 as a respective node in the graph, and identifies each synaptic connection between a pair of neurons in the image 510 as an edge between the corresponding pair of nodes in the graph.

The graphing system 512 may identify the neurons and the synapses depicted in the image 510 using any of a variety of techniques. For example, the graphing system 512 may process the image 510 to identify the positions of the neurons depicted in the image 510, and determine whether a synapse connects two neurons based on the proximity of the neurons (as will be described in more detail below). In this example, the graphing system 512 may process an input including: (i) the image, (ii) features derived from the image, or (iii) both, using a machine learning model that is trained using supervised learning techniques to identify neurons in images. The machine learning model can be, e.g., a convolutional neural network model or a random forest model. The output of the machine learning model may include a neuron probability map that specifies a respective probability that each voxel in the image is included in a neuron. The graphing system 512 may identify contiguous clusters of voxels in the neuron probability map as being neurons.

Optionally, prior to identifying the neurons from the neuron probability map, the graphing system 512 may apply one or more filtering operations to the neuron probability map, e.g., with a Gaussian filtering kernel. Filtering the neuron probability map may reduce the amount of “noise” in the neuron probability map, e.g., where only a single voxel in a region is associated with a high likelihood of being a neuron.

The machine learning model used by the graphing system 512 to generate the neuron probability map can be trained using supervised learning training techniques on a set of training data. The training data may include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuron. The target outputs of the training examples can be generated by manual annotation, e.g., where a person manually specifies which voxels of a training input are included in neurons.

Example techniques for identifying the positions of neurons depicted in the image 510 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 512 may identify the synapses connecting the neurons in the image 510 based on the proximity of the neurons. For example, the graphing system 512 may determine that a first neuron is connected by a synapse to a second neuron based on the area of overlap between: (i) a tolerance region in the image around the first neuron, and (ii) a tolerance region in the image around the second neuron. That is, the graphing system 512 may determine whether the first neuron and the second neuron are connected based on the number of spatial locations (e.g., voxels) that are included in both: (i) the tolerance region around the first neuron, and (ii) the tolerance region around the second neuron.

For example, the graphing system 512 may determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron can be specified as the set of spatial locations in the image that are either: (i) in the interior of the neuron, or (ii) within a predefined distance of the interior of the neuron.

The graphing system 512 may further identify a weight value associated with each edge in the graph 502. For example, the graphing system 512 may identify a weight for an edge connecting two nodes in the graph 502 based on the area of overlap between the tolerance regions around the respective neurons corresponding to the nodes in the image 510. The area of overlap can be measured, e.g., as the number of voxels in the image 510 that are contained in the overlap of the respective tolerance regions around the neurons. The weight for an edge connecting two nodes in the graph 502 can be understood as characterizing the (approximate) strength of the connection between the corresponding neurons in the brain (e.g., the amount of information flow through the synapse connecting the two neurons).

In addition to identifying synapses in the image 510, the graphing system 512 may further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 512 determines the directions of the synapses in the image 510, the graphing system 512 may associate each edge in the graph 502 with direction of the corresponding synapse. That is, the graph 502 can be a directed graph. In other implementations, the graph 502 can be an undirected graph, i.e., where the edges in the graph are not associated with a direction.

The graph 502 can be represented in any of a variety of ways. For example, the graph 502 can be represented as a two-dimensional array of numerical values with a number of rows and columns equal to the number of nodes in the graph. The component of the array at position (i,j) may have value 1 if the graph includes an edge pointing from node i to node j, and value 0 otherwise. In implementations where the graphing system 512 determines a weight value for each edge in the graph 502, the weight values can be similarly represented as a two-dimensional array of numerical values. More specifically, if the graph includes an edge connecting node i to node j, the component of the array at position (i,j) may have a value given by the corresponding edge weight, and otherwise the component of the array at position (i,j) may have value 0.

The synaptic connectivity graph 502 can be processed to determine the architecture of the brain emulation neural network 504 by using an architecture mapping system, which is a system of one or more computers in one or more locations. For example, the architecture mapping system may map each node in the graph 502 to: (i) an artificial neuron, (ii) a neural network layer, or (iii) a group of neural network layers, in the architecture of the brain emulation neural network 504. The architecture mapping system may further map each edge of the graph 502 to a connection in the brain emulation neural network 504, e.g., such that a first artificial neuron that is connected to a second artificial neuron is configured to provide its output to the second artificial neuron.

The architecture mapping system can use information about the surface of the brain, generated by the brain surface processing system 110, to instantiate the brain emulation neural network 504. For example, the architecture mapping system can map brain points located on the surface of the brain (e.g., brain points corresponding to spatial locations in the brain responsible for the processing of “raw” sensor data) to corresponding artificial input neurons in the brain emulation neural network 504. An input artificial neuron may refer to an artificial neuron that is configured to receive an input from a source that is external to the brain emulation neural network 504. A neuron in the brain can be considered to be located on the surface of the brain if it includes a brain point that is identified as being located on the surface of the brain, or if it is within a threshold distance of a brain point that is identified as being located on the surface of the brain.

The architecture mapping system may identify a sub-graph of the synaptic connectivity graph 502 and generate a brain emulation neural network architecture 504 based on the sub-graph. A “sub-graph” may refer to a graph specified by: (i) a proper subset of the nodes of the graph 502, and (ii) a proper subset of the edges of the graph 502. In one example, the architecture mapping system may select: (i) each node in the graph 502 corresponding to particular neuron type, and (ii) each edge in the graph 502 that connects nodes in the graph corresponding to the particular neuron type, for inclusion in the sub-graph. The neuron type selected for inclusion in the sub-graph can be, e.g., visual neurons, olfactory neurons, memory neurons, or any other appropriate type of neuron. In some cases, the architecture mapping system may select multiple neuron types for inclusion in the sub-graph, e.g., both visual neurons and olfactory neurons.

The type of neuron selected for inclusion in the sub-graph can be determined based on the task which the brain emulation neural network 504 will be configured to perform. In one example, the brain emulation neural network 504 can be configured to perform an image processing task, and neurons that are predicted to perform visual functions (i.e., by processing visual data) can be selected for inclusion in the sub-graph. In another example, the brain emulation neural network 504 can be configured to perform an odor processing task, and neurons that are predicted to perform odor processing functions (i.e., by processing odor data) can be selected for inclusion in the sub-graph. In another example, the brain emulation neural network 504 can be configured to perform an audio processing task, and neurons that are predicted to perform audio processing (i.e., by processing audio data) can be selected for inclusion in the sub-graph.

The architecture mapping system can identify a sub-graph of the synaptic connectivity graph by using information about the surface of the brain generated by the brain surface processing system 110. In one example, the architecture mapping system can search the space of possible sub-graphs of the synaptic connectivity graph and identify sub-graphs that contain nodes that correspond to neurons located on, or near, the brain's surface (e.g., neurons responsible for processing “raw” sensory data generated by the sensory organs).

In another example, a sub-graph of the synaptic connectivity graph can be identified manually by providing the visualization of the brain's surface (e.g., illustrated in FIG. 3) to a user. The user can identify a desired part of the brain in the visualization by, e.g., specifying a spatial region (e.g., a spherical region having a predefined radius) surrounding a surface neuron. The user-defined information can be used to instantiate a brain emulation neural network corresponding to the sub-graph included in the desired part of the brain.

For example, the user can specify a region of the brain surrounding the input terminal of the optic lobe. The architecture mapping system can generate a brain emulation neural network corresponding to the sub-graph included in the user-defined spatial region and provide it to a reservoir computing system, as will be described below with reference to FIG. 6. The architecture mapping system can instantiate visual input neurons located on the surface of the brain as artificial visual input neurons in the brain emulation neural network. The reservoir computing system can be configured to perform an image processing task by using the artificial visual neurons selected for inclusion in the sub-graph.

Determining the architecture of the brain emulation neural network 504 based on the sub-graph rather than the overall synaptic connectivity graph 502 may result in the architecture having a reduced complexity, e.g., because the sub-graph has fewer nodes, fewer edges, or both than the graph 502. Reducing the complexity of the architecture may reduce consumption of computational resources (e.g., memory and computing power) by the brain emulation neural network 504, e.g., enabling the brain emulation neural network 504 to be deployed in resource-constrained environments, e.g., mobile devices. Reducing the complexity of the architecture may also facilitate training of the brain emulation neural network 504, e.g., by reducing the amount of training data required to train the brain emulation neural network 504 to achieve an threshold level of performance (e.g., prediction accuracy).

The architecture mapping system may determine the architecture of the brain emulation neural network 504 from the sub-graph in any of a variety of ways. For example, the architecture mapping system may map each node in the sub-graph to a corresponding: (i) artificial neuron, (ii) artificial neural network layer, or (iii) group of artificial neural network layers in the architecture, as will be described in more detail next. In one example, the neural network architecture may include: (i) a respective artificial neuron corresponding to each node in the sub-graph, and (ii) a respective connection corresponding to each edge in the sub-graph. In this example, the sub-graph can be a directed graph, and an edge that points from a first node to a second node in the sub-graph may specify a connection pointing from a corresponding first artificial neuron to a corresponding second artificial neuron in the architecture. The connection pointing from the first artificial neuron to the second artificial neuron may indicate that the output of the first artificial neuron should be provided as an input to the second artificial neuron. Each connection in the architecture can be associated with a weight value, e.g., that is specified by the weight value associated with the corresponding edge in the sub-graph.

An artificial neuron may refer to a component of the architecture that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron may generate an output b as:

$$b = σ ( {\sum }_{i = 1}^{n} {w}_{i} \cdot {a}_{i} ) \qquad ( 1 )$$

where σ(⋅) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the sub-graph can be an undirected graph, and the architecture mapping system may map an edge that connects a first node to a second node in the sub-graph to two connections between a corresponding first artificial neuron and a corresponding second artificial neuron in the architecture. In particular, the architecture mapping system may map the edge to: (i) a first connection pointing from the first artificial neuron to the second artificial neuron, and (ii) a second connection pointing from the second artificial neuron to the first artificial neuron.

In another example, the sub-graph can be an undirected graph, and the architecture mapping system may map an edge that connects a first node to a second node in the sub-graph to one connection between a corresponding first artificial neuron and a corresponding second artificial neuron in the architecture. The architecture mapping system may determine the direction of the connection between the first artificial neuron and the second artificial neuron, e.g., by randomly sampling the direction in accordance with a probability distribution over the set of two possible directions.

In some cases, the edges in the sub-graph may not be associated with weight values, and the weight values corresponding to the connections in the architecture can be determined randomly. For example, the weight value corresponding to each connection in the architecture may be randomly sampled from a predetermined probability distribution, e.g., a standard Normal (N(0,1)) probability distribution.

In another example, the neural network architecture may include: (i) a respective artificial neural network layer corresponding to each node in the sub-graph, and (ii) a respective connection corresponding to each edge in the sub-graph. In this example, a connection pointing from a first layer to a second layer may indicate that the output of the first layer should be provided as an input to the second layer. An artificial neural network layer may refer to a collection of artificial neurons, and the inputs to a layer and the output generated by the layer can be represented as ordered collections of numerical values (e.g., tensors of numerical values). In one example, the architecture may include a respective convolutional neural network layer corresponding to each node in the sub-graph, and each given convolutional layer may generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each edge can be specified by the weight value associated with the corresponding edge in the sub-graph), h_{θ}(⋅) represents the operation of applying one or more convolutional kernels to an input to generate a corresponding output, and σ(⋅) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping system may determine that the neural network architecture includes: (i) a respective group of artificial neural network layers corresponding to each node in the sub-graph, and (ii) a respective connection corresponding to each edge in the sub-graph. The layers in a group of artificial neural network layers corresponding to a node in the sub-graph can be connected, e.g., as a linear sequence of layers, or in any other appropriate manner.

The neural network architecture may include one or more artificial neurons that are identified as “input” artificial neurons and one or more artificial neurons that are identified as “output” artificial neurons. An input artificial neuron may refer to an artificial neuron that is configured to receive an input from a source that is external to the brain emulation neural network 504. An output artificial neural neuron may refer to an artificial neuron that generates an output which is considered part of the overall output generated by the brain emulation neural network 504. The brain emulation neural network 504 can be provided the reservoir computing system 600, which will be described in more detail next.

FIG. 6 shows an example reservoir computing system 600. The reservoir computing system 600 is an example of a system implemented as computer programs on one or more computers in one or more locations in which the systems, components, and techniques described below are implemented.

The reservoir computing system 600 includes a reservoir computing neural network 602 having at least two sub-networks: (i) a brain emulation neural network 504, and (ii) a prediction neural network 604. The reservoir computing neural network 602 is configured to process a network input 606 to generate a network output 607. More specifically, the brain emulation neural network 504 is configured to process the network input 606 in accordance with a set of model parameters 610 of the brain emulation neural network 504 to generate an alternative representation 612 of the network input 606. The prediction neural network 604 is configured to process the alternative representation 612 of the network input 606 in accordance with a set of model parameters 614 of the prediction neural network 604 to generate the network output 608.

The brain emulation neural network 504 can include one or more parameters that are not trained, while the prediction sub-network 604 can include parameters that are trained. The reservoir computing system 600 can include multiple brain emulation sub-networks and multiple other sub-networks having parameters that are trained. For example, the reservoir computing system 600 can include an initial neural network layer with trainable parameters, followed by a sub-network layer having parameters that are not trained (e.g., a first brain emulation neural network), followed by a third neural network layer with trainable parameters, followed by another sub-network having parameters that are not trained (e.g., a second brain emulation neural network), followed by an output neural network layer. Other configurations of the reservoir computing system 600 are also possible.

The brain emulation neural network 504 may have an architecture that is based on a graph representing synaptic connectivity between neurons in the brain of a biological organism. In some cases, the architecture of the brain emulation neural network 504 can be specified by the synaptic connectivity between neurons of a particular type in the brain, e.g., neurons from the visual system or the olfactory system. Generally, the brain emulation neural network 504 has a more complex neural network architecture than the prediction neural network 604. In one example, the prediction neural network 604 may include only one neural network layer (e.g., a fully-connected layer) that processes the alternative representation 612 of the network input 606 to generate the network output 608.

The information about the surface of the brain, obtained by the brain surface processing system 110, can be used to instantiate the brain emulation neural network. As described above with reference to FIG. 5, the brain emulation neural network architecture can include artificial input neurons that correspond to neurons identified as being located on the brain's surface by the system 110 (e.g., sensory input neurons). The brain emulation neural network architecture can also be based on a sub-graph of the synaptic connectivity graph. The sub-graph can be chosen by automatically searching through the space of possible sub-graphs that are located on, or close to, the brain's surface, or by manually selecting a particular sub-graph based on the visualization of the brain's surface (e.g., illustrated in FIG. 3).

In some cases, the brain emulation neural network 504 may have a recurrent neural network architecture, i.e., where the connections in the architecture define one or more “loops.” More specifically, the architecture may include a sequence of components (e.g., artificial neurons, layers, or groups of layers) such that the architecture includes a connection from each component in the sequence to the next component, and the first and last components of the sequence are identical. In one example, two artificial neurons that are each directly connected to one another (i.e., where the first neuron provides its output the second neuron, and the second neuron provides its output to the first neuron) would form a recurrent loop.

A recurrent brain emulation neural network may process a network input over multiple (internal) time steps to generate a respective alternative representation 612 of the network input at each time step. In particular, at each time step, the brain emulation neural network may process: (i) the network input, and (ii) any outputs generated by the brain emulation neural network at the preceding time step, to generate the alternative representation for the time step. The reservoir computing neural network 602 may provide the alternative representation of the network input generated by the brain emulation neural network at the final time step as the input to the prediction neural network 604. The number of time steps over which the brain emulation neural network 504 processes a network input can be a predetermined hyper-parameter of the reservoir computing system 600.

In addition to processing the alternative representation 612 generated by the output layer of the brain emulation neural network 504, the prediction neural network 604 may additionally process one or more intermediate outputs of the brain emulation neural network 504. An intermediate output refers to an output generated by a hidden artificial neuron of the brain emulation neural network, i.e., an artificial neuron that is not included in the input layer or the output layer of the brain emulation neural network.

The reservoir computing system 600 can include other sub-networks, e.g., an input sub-network that generates an embedding of the network input. An embedding of a network input can refer to an ordered collection of numerical values (e.g., a vector or matrix of numerical values) representing the network input. For example, an embedding of a network input can be a compact representation of the network input that implicitly encodes features (e.g., semantic features) of the network input. The embedding of the network input can be provided to the brain emulation neural network. More specifically, the network input (or the embedding of the network input) can be provided to artificial input neurons of the brain emulation neural network that are identified from the brain's surface.

The reservoir computing system 600 includes a training engine 616 that is configured to train the reservoir computing neural network 602. Training the reservoir computing neural network 602 from end-to-end (i.e., training both the model parameters 610 of the brain emulation neural network 504 and the model parameters 614 of the prediction neural network 604) can be difficult due to the complexity of the architecture of the brain emulation neural network. In particular, the brain emulation neural network may have a very large number of trainable parameters and may have a highly recurrent architecture (i.e., an architecture that includes loops, as described above).

Therefore, training the reservoir computing neural network 602 from end-to-end using machine learning training techniques can be computationally-intensive and the training may fail to converge, e.g., if the values of the model parameters of the reservoir computing neural network 602 oscillate rather than converging to fixed values. Even in cases where the training of the reservoir computing neural network 602 converges, the performance of the reservoir computing neural network 602 (e.g., measured by prediction accuracy) may fail to achieve an acceptable threshold. For example, the large number of model parameters of the reservoir computing neural network 602 may overfit the limited amount of training data.

Rather than training the entire reservoir computing neural network 602 from end-to-end, the training engine 616 only trains the model parameters 614 of the prediction neural network 604 while leaving the model parameters 610 of the brain emulation neural network 504 fixed during training. The model parameters 610 of the brain emulation neural network 504 can be determined before the training of the prediction neural network 604 based on the weight values of the edges in the synaptic connectivity graph, as described above. Optionally, the weight values of the edges in the synaptic connectivity graph can be transformed (e.g., by additive random noise) prior to being used for specifying model parameters 610 of the brain emulation neural network 504. This training procedure enables the reservoir computing neural network 602 to take advantage of the highly complex and non-linear behavior of the brain emulation neural network 504 in performing prediction tasks while obviating the challenges of training the brain emulation neural network 504.

The training engine 616 may train the reservoir computing neural network 602 on a set of training data over multiple training iterations. The training data may include a set of training examples, where each training example specifies: (i) a training network input, and (ii) a target network output that should be generated by the reservoir computing neural network 602 by processing the training network input.

At each training iteration, the training engine 616 may sample a batch of training examples from the training data, and process the training inputs specified by the training examples using the reservoir computing neural network 602 to generate corresponding network outputs 608. In particular, the reservoir computing neural network 602 processes each network input 606 in accordance with the static model parameter values 610 of the brain emulation neural network 504 to generate an alternative representation 612 of the network input 606. The reservoir computing neural network 602 then processes the alternative representation 612 using the current model parameter values 614 of the prediction neural network 604 to generate the network output 608.

The training engine 616 adjusts the model parameter values 614 of the prediction neural network 604 to optimize an objective function that measures a similarity between: (i) the network outputs 608 generated by the reservoir computing neural network 602, and (ii) the target network outputs specified by the training examples. The objective function can be, e.g., a cross-entropy objective function, a squared-error objective function, or any other appropriate objective function.

To optimize the objective function, the training engine 616 may determine gradients of the objective function with respect to the model parameters 614 of the prediction neural network 604, e.g., using backpropagation techniques. The training engine 616 may then use the gradients to adjust the model parameter values 614 of the prediction neural network, e.g., using any appropriate gradient descent optimization technique, e.g., an RMSprop or Adam gradient descent optimization technique.

The training engine 616 may use any of a variety of regularization techniques during training of the reservoir computing neural network 602. For example, the training engine 616 may use a dropout regularization technique, such that certain artificial neurons of the brain emulation neural network are “dropped out” (e.g., by having their output set to zero) with a non-zero probability p>0 each time the brain emulation neural network processes a network input. Using the dropout regularization technique may improve the performance of the trained reservoir computing neural network 602, e.g., by reducing the likelihood of over-fitting. An example dropout regularization technique is described with reference to: N. Srivastava, et al.: “Dropout: a simple way to prevent neural networks from overfitting,” Journal of Machine Learning Research 15 (2014) 1929-1958. As another example, the training engine 616 may regularize the training of the reservoir computing neural network 602 by including a “penalty” term in the objective function that measures the magnitude of the model parameter values 714 of the prediction neural network 604. The penalty term can be, e.g., an L₁ or L₂ norm of the model parameter values 614 of the prediction neural network 604.

In some cases, the values of the intermediate outputs of the brain emulation neural network 504 may have large magnitudes, e.g., as a result from the parameter values of the brain emulation neural network 504 being derived from the weight values of the edges of the synaptic connectivity graph rather than being trained. Therefore, to facilitate training of the reservoir computing neural network 602, batch normalization layers can be included between the layers of the brain emulation neural network 504, which can contribute to limiting the magnitudes of intermediate outputs generated by the brain emulation neural network. Alternatively or in combination, the activation functions of the neurons of the brain emulation neural network can be selected to have a limited range. For example, the activation functions of the neurons of the brain emulation neural network can be selected to be sigmoid activation functions with range given by [0,1].

The reservoir computing neural network 602 can be configured to perform any appropriate task. A few examples follow.

In one example, the reservoir computing neural network 602 can be configured to generate a classification output that classifies the network input into a predefined number of possible categories. For example, the network input can be an image, each category may specify a type of object (e.g., person, vehicle, building, and the like), and the reservoir computing neural network 602 may classify an image into a category if the image depicts an object included in the category. As another example, the network input can be an odor, each category may specify a type of odor (e.g., decomposing or not decomposing), and the reservoir computing neural network 602 may classify an odor into a category if the odor is of the type specified by the category.

In another example, the reservoir computing neural network 602 can be configured to generate an action selection output that can be used to select an action to be performed by an agent interacting with an environment. For example, the action selection output may specify a respective score for each action in a set of possible actions that can be performed by the agent, and the agent may select the action to be performed by sampling an action in accordance with the action scores. In one example, the agent can be a mechanical agent interacting with a real-world environment to perform a navigation task (e.g., reaching a goal location in the environment), and the actions performed by the agent cause the agent to navigate through the environment.

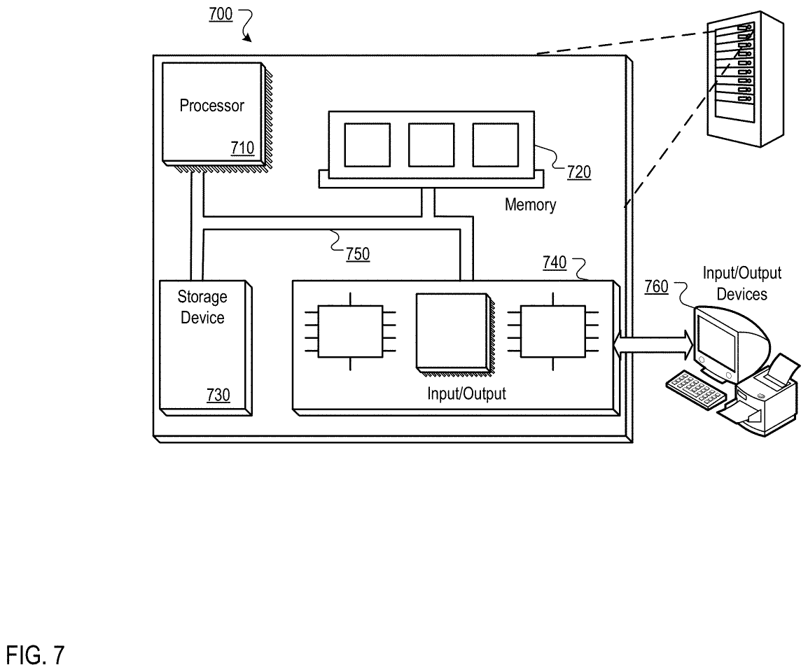

FIG. 7 is a block diagram of an example computer system 700 that can be used to perform operations described previously. The system 700 includes a processor 710, a memory 720, a storage device 730, and an input/output device 740. Each of the components 710, 720, 730, and 740 can be interconnected, for example, using a system bus 750. The processor 610 is capable of processing instructions for execution within the system 700. In one implementation, the processor 610 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can include, for example, a hard disk device, an optical disk device, a storage device that is shared over a network by multiple computing devices (for example, a cloud storage device), or some other large capacity storage device.

The input/output device 740 provides input/output operations for the system 700. In one implementation, the input/output device 740 can include one or more network interface devices, for example, an Ethernet card, a serial communication device, for example, and RS-232 port, and/or a wireless interface device, for example, and 602.11 card. In another implementation, the input/output device 740 can include driver devices configured to receive input data and send output data to other input/output devices, for example, keyboard, printer and display devices 760. Other implementations, however, can also be used, such as mobile computing devices, mobile communication devices, and set-top box television client devices.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more data processing apparatus, the method comprising:
obtaining a point cloud dataset representing a brain of a biological organism, wherein the point cloud dataset comprises a collection of brain points that each define a respective spatial location in the brain;
identifying a plurality of brain points from the point cloud dataset as being located on a surface of the brain by repeatedly performing operations comprising:
initializing a current value of a position parameter;
iteratively adjusting the current value of the position parameter until a termination criterion is satisfied, wherein the termination criterion is satisfied if at least one brain point from the point cloud dataset is included in an interior of a shape parameterized by the current value of the position parameter; and
after determining that the termination criterion is satisfied, identifying each brain point from the point cloud dataset that is included in the interior of the shape parameterized by the current value of the position parameter as being located on the surface of the brain.

2. The method of claim 1, wherein the biological organism is an animal.

3. The method of claim 1, wherein the biological organism is a fly.

4. The method of claim 1, wherein the shape parametrized by the current value of the position parameter is a sphere having a predefined radius.

5. The method of claim 1, wherein initializing the current value of the position parameter comprises:
initializing a box that encloses the point cloud dataset; and
initializing the current value of the position parameter such that the shape parametrized by the position parameter is positioned at a boundary of the box.

6. The method of claim 1, further comprising rendering a visualization of the plurality of brain points identified as being located on the surface of the brain, wherein the visualization comprises a plurality of markers, and wherein each marker indicates a position of each brain point of the plurality of brain points.

7. The method of claim 1, wherein the method is performed by multiple data processing apparatus in parallel.

8. The method of claim 1, further comprising:
obtaining graph data defining a synaptic connectivity graph that represents synaptic connectivity between neurons in the brain of the biological organism, wherein the synaptic connectivity graph comprises a plurality of nodes and edges; and
instantiating a reservoir computing neural network comprising: (i) a brain emulation neural network having a neural network architecture that is specified by the synaptic connectivity graph and (ii) a prediction neural network.

9. The method of claim 8, wherein instantiating the reservoir computing network comprises instantiating the brain emulation neural network having the neural network architecture that is specified by the synaptic connectivity graph, comprising:
mapping each node in the synaptic connectivity graph to a corresponding artificial neuron in the neural network architecture; and
mapping each edge connecting a pair of nodes in the synaptic connectivity graph to a connection between a corresponding pair of artificial neurons in the neural network architecture.

10. The method of claim 9, wherein mapping each node in the synaptic connectivity graph to a corresponding artificial neuron in the neural network architecture comprises:
mapping each node that corresponds to one or more brain points of the plurality of brain points identified as being located on the surface of the brain to a corresponding artificial input neuron in the neural network architecture.

11. The method of claim 8, wherein instantiating the reservoir computing network comprises instantiating the brain emulation neural network having the neural network architecture that is specified by a sub-graph of the synaptic connectivity graph, wherein the sub-graph is selected based on a visualization of the plurality brain points identified as being located on the surface of the brain.

12. The method of claim 8, wherein each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism.

13. The method of claim 10, wherein the reservoir computing network is configured to process an input that comprises image data, video data, audio data, odor data, point cloud data, magnetic field data, or a combination thereof, to generate an output.

14. The method of claim 1, wherein iteratively adjusting the current value of the position parameter comprises changing a position of the shape parametrized by the current value of the position parameter along the same direction at each iteration.

15. The method of claim 1, wherein iteratively adjusting the current value of the position parameter comprises changing a position of the shape parametrized by the current value of the position parameter along a random direction at each iteration.

16. One or more non-transitory computer storage media storing instructions that when executed by one or more computers cause the one or more computers to perform operations comprising:
obtaining a point cloud dataset representing a brain of a biological organism, wherein the point cloud dataset comprises a collection of brain points that each define a respective spatial location in the brain;
identifying a plurality of brain points from the point cloud dataset as being located on a surface of the brain by repeatedly performing operations comprising:
initializing a current value of a position parameter;
iteratively adjusting the current value of the position parameter until a termination criterion is satisfied, wherein the termination criterion is satisfied if at least one brain point from the point cloud dataset is included in an interior of a shape parameterized by the current value of the position parameter; and
after determining that the termination criterion is satisfied, identifying each brain point from the point cloud dataset that is included in the interior of the shape parameterized by the current value of the position parameter as being located on the surface of the brain.

17. The one or more non-transitory computer storage media of claim 16, wherein the shape parametrized by the current value of the position parameter is a sphere having a predefined radius.

18. The one or more non-transitory computer storage media of claim 16, wherein initializing the current value of the position parameter comprises:
initializing a box that encloses the point cloud dataset; and
initializing the current value of the position parameter such that the shape parametrized by the position parameter is positioned at a boundary of the box.

19. The one or more non-transitory computer storage media of claim 16, further comprising rendering a visualization of the plurality of brain points identified as being located on the surface of the brain, wherein the visualization comprises a plurality of markers, and wherein each marker indicates a position of each brain point of the plurality of brain points.

20. A system comprising:
one or more computers; and
one or more storage devices commutatively coupled to the one or more computers, wherein the one or more storage devices store instructions that, when executed by one or more computers, cause one or more computers to perform operations comprising:
obtaining a point cloud dataset representing a brain of a biological organism, wherein the point cloud dataset comprises a collection of brain points that each define a respective spatial location in the brain;
identifying a plurality of brain points from the point cloud dataset as being located on a surface of the brain by repeatedly performing operations comprising:
initializing a current value of a position parameter;
iteratively adjusting the current value of the position parameter until a termination criterion is satisfied, wherein the termination criterion is satisfied if at least one brain point from the point cloud dataset is included in an interior of a shape parameterized by the current value of the position parameter; and
after determining that the termination criterion is satisfied, identifying each brain point from the point cloud dataset that is included in the interior of the shape parameterized by the current value of the position parameter as being located on the surface of the brain.
